(19) United States
(12) Patent Application Publication
(10) Pub. No.: US 2003/0223345 A1
(43) Pub. Date: Dec. 4, 2003

(54) Optical disk apparatus with different transmission factors for polarized light

(75) Inventors: Kazushi Uno, Kawasaki-shi (JP); Koichi Tezuka, Kawasaki-shi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/292,757

(22) Filed: Nov. 13, 2002

(30) Foreign Application Priority Data
May 31, 2002 (JP) 2002-158695

(51) Int. Cl. G11B 7/135

(52) U.S. Cl. 369/112.16; 369/110.04; 369/112.17

(57) ABSTRACT

An optical disk apparatus includes a light source for emitting light in a prescribed wavelength range, an objective lens system for causing the light emitted from the light source to be focused onto a storage disk, and a reproduction signal system for causing return light from the storage disk to be conduced to a detector. The light emitted from the light source has a direction of polarization parallel to a recoding track of the storage disk. The objective lens system has transmission factors for s-polarized light and p-polarized light that are defined relative to the objective lens system. The transmission factor for s-polarized light is greater than the transmission factor for p-polarized light.

### BACKGROUND OF THE INVENTION

1. Field of the Invention

The present invention relates to an optical disk apparatus, and in particular to apparatus provided with an objective lens system of a high numerical aperture (NA) and with a light source of short wavelength for an optical pickup.

2. Description of the Related Art

As known in the art, one way for achieving high-density data recording or high-density data reading with respect to an optical disk, is to reduce the diameter of the light spot formed on the recording layer of the optical disk. There are two options for effecting the diameter reduction. The first option is to decrease the wavelength of the irradiating light (by using a blue laser diode, for example) The second option is to increase the NA of the objective lens system.

Regarding the first option, a blue laser diode or LD (wavelength: 400-405 nm) used for the light source is unpreferable to a red LD (wavelength: 660-685 nm) since the sensitivity of a detector may deteriorate by about 40%. Disadvantageously, the reduced sensitivity entails the decline of S/N ratio for reproduction signals. Besides, light of a shorter wavelength is more likely to be absorbed by transparent components of the disk apparatus, such as lenses and light splitting prisms. This may also result in the decline of S/N ratio for reproduction signals.

Regarding the second option, an objective lens system having a great NA causes light to converge sharply, as shown in FIG. 1, in comparison with a small NA system. The sharp conversion of light, however, can make it difficult to keep the information about the polarization of light passing through transparent components (such as an objective lens or a coil carriage facing the storage disk) or being reflected on an optical disk. Such insufficient information about polarization of light will lead to the deterioration of the S/N ratio for reproduction signals.

### SUMMARY OF THE INVENTION

The present invention has been proposed under the circumstances described above. It is, therefore, an object of the present invention to provide an optical disk apparatus that makes use of an objective lens of a great NA but still can enjoy a good S/N ratio for reproduction signals.

According to a first aspect of the present invention, there is provided an optical disk apparatus including: a light source for emitting light in a prescribed wavelength range; an objective lens system for causing the light emitted from the light source to be focused onto a storage disk; and a reproduction signal system for causing return light from the storage disk to be conduced to a detector. The light emitted from the light source has a direction of polarization parallel to a recoding track of the storage disk. The objective lens system has transmission factors for s-polarized light and p-polarized light that are defined relative to the objective lens system. The transmission factor for s-polarized light is greater than the transmission factor for p-polarized light.

Preferably, the objective lens system may include an objective lens and a transparent member located between the objective lens and the storage disk. The objective lens and/or the transparent member is formed with a transmission control film.

According to a second aspect of the present invention, there is provided an optical disk apparatus including: a light source for emitting light in a prescribed wavelength range; an objective lens system for causing the light emitted from the light source to be focused onto a storage disk; and a reproduction signal system for causing return light from the storage disk to be conducted to a detector. The light emitted from the light source has a direction of polarization perpendicular to a recoding track of the storage disk. The objective lens system has transmission factors for s-polarized light and p-polarized light that are defined relative to the objective lens system. The transmission factor for p-polarized light is greater than the transmission factor for s-polarized light.

According to a third aspect of the present invention, there is provided an optical disk apparatus including: a light source; an objective lens system for causing light emitted from the light source to be focused onto a storage disk; and a reproduction signal system for causing return light from the storage disk to be conducted to a detector, the reproduction signal system being provided with a transparent member having an incident surface and an exit surface. The incident surface and/or the exit surface is an inclined surface that is slant relative to the return light and covered by a dielectric layer.

Preferably, the return light may include a p-polarized component and an s-polarized component that are defined relative to the inclined surface. The transparent member may be provided with a plurality of return light irradiating regions having different transmission factors resulting from the dielectric layer.

Preferably, the light emitted from the light source may have a direction of polarization parallel to a recording track of the storage disk. The return light irradiating regions may include first marginal regions spaced from each other in a direction corresponding to a track-crossing direction and a second marginal region different from the first marginal regions. The first marginal regions are smaller in transmission factor for polarized light than the second marginal region.

Preferably, the light emitted from the light source may have a direction of polarization perpendicular to a recording track of the storage disk. The return light irradiating regions may include first marginal regions spaced from each other in a direction corresponding to a track-crossing direction and a second marginal region different from the first marginal regions. The second marginal region may be smaller in transmission factor for polarized light than the first marginal regions.

Preferably, the transparent member may be provided with a plurality of regions having different P-S phase differences with respect to p-polarized and s-polarized components defined relative to the inclined surface.

Preferably, the plurality of regions may include a first region corresponding to a center of the return light, second regions spaced in a direction corresponding to a track-crossing direction, and third regions spaced in a direction corresponding to a track-extending direction. The P-S phase difference given to the second regions is smaller than the P-S phase difference given to the first region, and the P-S phase difference given to the third regions is greater than the P-S phase difference given to the first region.

Other features and advantages of the present invention will become apparent from the detailed description given below with reference to the accompanying drawings.

### BRIEF DESCRIPTION OF THE DRAWINGS

FIG. 1 shows a conventional objective lens system used for an optical disk apparatus;

FIG. 2 shows principal components of an optical disk apparatus embodying the present invention;

FIGS. 3 and 4 illustrate the operating principles of the present invention;

FIGS. 5A-5D show an example of a second transparent member used for the disk apparatus of the present invention, where the obverse and reverse surfaces of the transparent member are divided into prescribed regions;

FIG. 5E is a table of Tp, Ts and P-S phase difference given to the respective regions shown in FIGS. 5A-5D;

FIGS. 6A and 6B show another example of a second transparent member used for the disk apparatus of the present invention;

FIG. 6C is a table of Tp, Ts and P-S phase difference given to the respective regions shown in FIGS. 6A and 6B;

FIGS. 7A and 7B show another example of a second transparent member used for the disk apparatus of the present invention; and

FIG. 7C is a table of Tp, Ts and P-S phase difference given to the respective regions shown in FIGS. 7A and 7B.

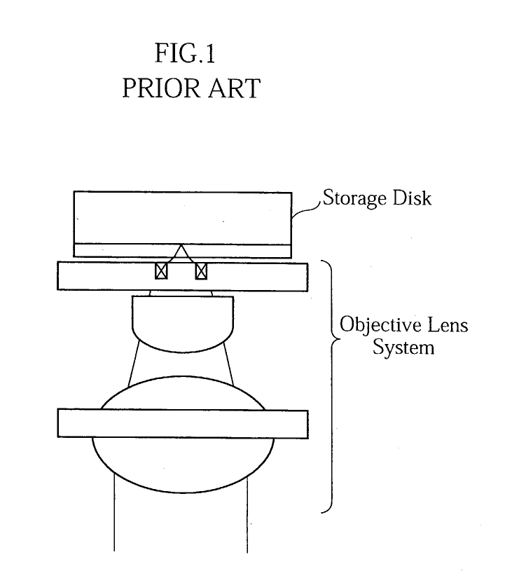

### DETAILED DESCRIPTION OF THE PREFERRED EMBODIMENT

A preferred embodiment of the present invention will be described below with reference to the accompanying drawings.

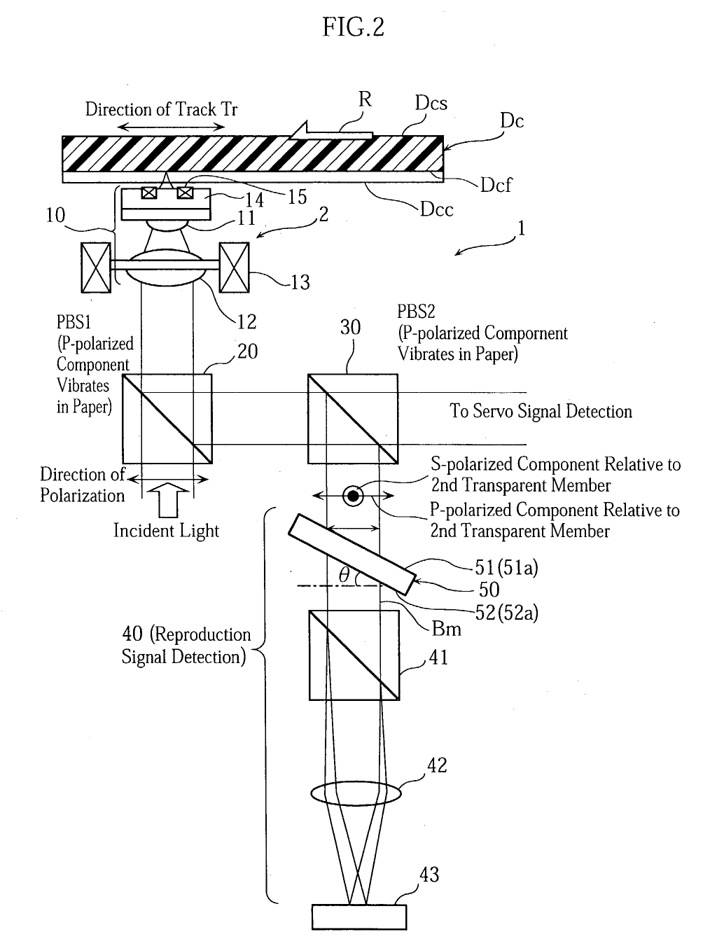

FIG. 2 shows principal components of an optical disk apparatus 1 embodying the present invention. Numeral 2 refers to an optical pickup of the apparatus 1. The pickup 2 is provided with a lens system 10 that includes an upper or first objective lens 11 and a lower or second objective lens 12. The first lens 11 is disposed closer to an optical data storage disk Dc than the second lens 12. The second lens 12 is supported by a carriage (not shown) via a two-dimensional actuator 13 responsible for tracking/focusing servocontrol. For seeking operation, the unillustrated carriage is moved in a radial direction of the disk Dc by a driving mechanism utilizing a voice coil motor, for example. The first lens is mounted on a slider that can float over the disk Dc being rotated. The slider is supported by the unillustrated carriage via a suspension. In the illustrated example, the first lens 11 is formed integral with a first transparent member 14 which has a generally flat surface facing the disk Dc. A coil 15 for magnetic field modulation is embedded in the transparent member 14 and has an inner diameter larger enough to pass the light irradiating the disk Dc.

The disk Dc includes a resin substrate Dcs, a recoding layer Dcf formed on one side of the substrate, and a protection coating Dcc covering the recoding layer Dcf. As in a conventional disk, the recoding layer Dcf is formed with spiral recoding tracks Tr. In FIG. 2, the substrate Dcs of the disk Dc is shown in section taken along a recoding track, and an arrow R indicates the direction in which the disk Dc is rotated.

The light source (not shown) includes a blue laser diode (LD) that emits laser beams of a short wavelength. The emitted laser beam is polarized, the direction of polarization being parallel to the track Tr. The emitted laser beam passes through a first beam splitter 20 and enters the lens system 10. The lens system 10 causes the laser beam to converge and to form a light spot Sp on the recoding layer Dcf of the disk Dc. The return light Bm from the recoding layer Dcf passes backward through the lens system 10. Then, the course of the return light Bm is changed by the first beam splitter 20 toward a second beam splitter 30. Then, the return light Bm is split into two beams by the second beam splitter 30. As shown in FIG. 2, one of the beams is directed toward a servo signal detecting unit, while the other toward a reproduction signal detecting unit 40. In the servo signal detecting unit, a tracking servo signal and a focusing servo signal are to be detected. In the reproduction signal detecting unit 40, the return beam Bm passes through a Wollaston prism 41, and is converged by a lens 42 to be received by a detector 43 for output of reproduction signals. Between the second beam splitter 30 and the Wollaston prism 41 is provided a second transparent member 50 traversing the light path at prescribed angles. The technical significance of the second transparent member 50 will be described later.

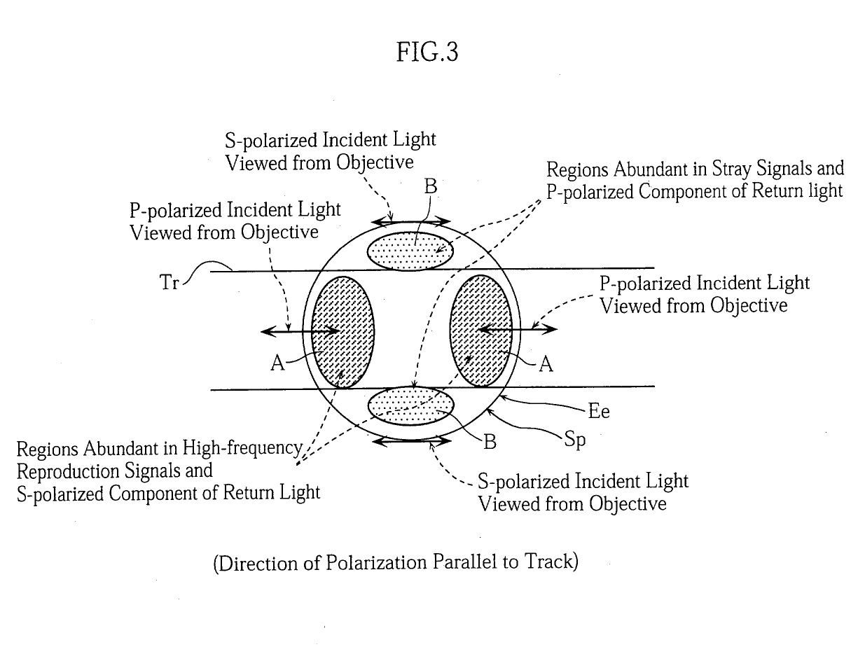

To illustrate the operating principle of the present invention, reference is now made to FIG. 3 showing a light spot Sp formed on the recoding track Tr and a pupil Ee of the lens system 10. The diameter of the light spot Sp, which is slightly greater than the width of the track Tr, is determined by the trade-off between high-density recording with the disk Dc and reliable acquisition of track error signals.

FIG. 3 shows two (first and second) pairs of elliptic marginal regions A, B in the pupil Ee. The first paired regions A are spaced from each other in the longitudinal direction of the track Tr. The second paired regions B are spaced from each other in a direction perpendicular to the longitudinal direction of the track Tr. The light emitted from the light source of the disk apparatus 1 passes through the pupil Ee. Specifically, p-polarized light (as viewed from the lens system 10) passes through the first paired regions A, while s-polarized light passes through the second paired regions B. The plane of polarization is rotated when the light is reflected on the recoding layer Dcf of the disk (known as “magnetic Kerr effect”), so that the s-polarized component of the return light (i.e., reproduction signal) will pass through the first paired regions A, and that the p-polarized component of the return light will pass through the second paired regions B.

The return light is dissolved into high-frequency components and low-frequency components. The high-frequency components are more likely to be present in the first paired regions A than in the other portions of the pupil Ee. In the second paired regions B, on the other hand, stray signals (i.e., noise) from the adjacent tracks are more likely to be present. (As known in the art, the occurrence of stray signals depends on the ratio of the recording track pitch to the diameter of the light spot Sp.) In summary, when the plane of polarization is parallel to the recording track Tr as in the case of FIG. 3, the s-polarized component of the return light contains a lot of high-frequency signals, while the p-polarized component of the return light contains a lot of stray signals. To enjoy a high S/N ratio for the reproduction signal, arrangements need to be made to make less use of the noise-contaminated p-polarized component. To achieve this in the illustrated embodiment, the transmission factor Ts for the s-polarized light is made greater than the transmission factor Tp for the p-polarized light in the following manner.

As previously noted, the lens system 10 of FIG. 2 includes the first lens 11, the second lens 12 and the first transparent member 14. According to the present invention, these components are coated with a transmission control film so that the average transmission factor Ts of the lens system 10 is greater than the average transmission factor Tp. Specifically, the average factor Ts may be 97%, and the average factor Tp may be 93%. However, locally (that is, in the outer parts of the light path), the transmission factor Ts may be rendered 95%, and the transmission factor Tp may be rendered 90%. Accordingly, after the light is reflected on the recording layer Dcf, high-frequency reproduction signals present in the s-polarized light are intensified, whereas stray signals present in the p-polarized light are diminished.

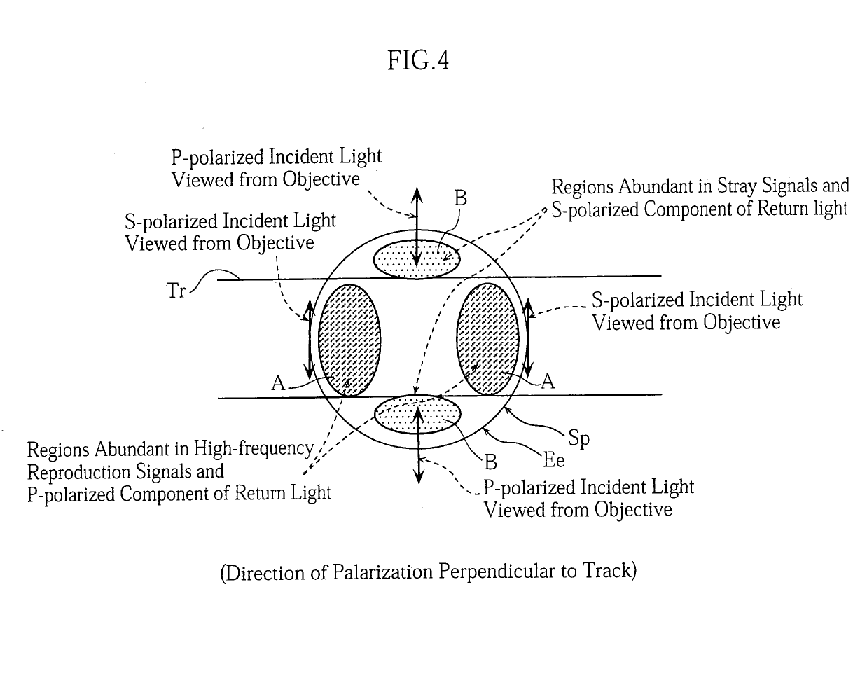

FIG. 4 shows a situation similar to that shown in FIG. 3 except that the plane of polarization of incident light is perpendicular to the longitudinal direction of the recording track Tr. In this instance, as opposed to the case of FIG. 3, s-polarized light (viewed from the lens system 10) passes through the first paired regions A, while p-polarized light passes through the second paired regions B. Regarding the return light, the p-polarized component is present in the regions A, while the s-polarized component is present in the regions B. In the case of FIG. 4, likewise to that of FIG. 3, high-frequency signals in the return light are likely to be present in the first regions A, and stray signals from the adjacent tracks are likely to be present in the second regions B. Thus, it follows that the p-polarized return light contains a lot of high-frequency reproduction signals, and the s-polarized return light contains a lot of stray signals. Thus, to enjoy a high S/N ratio for the reproduction signal, arrangements may be made to render the p-polarized light transmission factor Tp greater than the s-polarized light transmission factor Ts, so that the noise-contaminated s-polarized component of the return light is made less use of.

Referring back to the embodiment shown in FIG. 2, wherein the direction of polarization of the incident light is parallel to the longitudinal direction of the track Tr, the first beam splitter 20 is adjusted so that the reflectivity of the s-polarized light is substantially 100%. Likewise, in the second beam splitter 30, the reflectivity of the s-polarized light is substantially 100%. With such an arrangement, the s-polarized component of the return light is conducted toward the reproduction signal detecting system 40, to pass through the second transparent member 50. The transparent member 50 is inclined relative to the path of the return light. In the illustrated example, the inclination angle θ is 30°.

The second transparent member 50 has an incident surface 51 and an exit surface 52 opposite and parallel to the incident surface 51. The incident and exit surfaces 51, 52 are coated with dielectric layers 51a and 52a, respectively. Since the second transparent member 50 is inclined to the return light Bm, it is possible to define “p-polarized” and “s-polarized” in relation to the second transparent member 50.

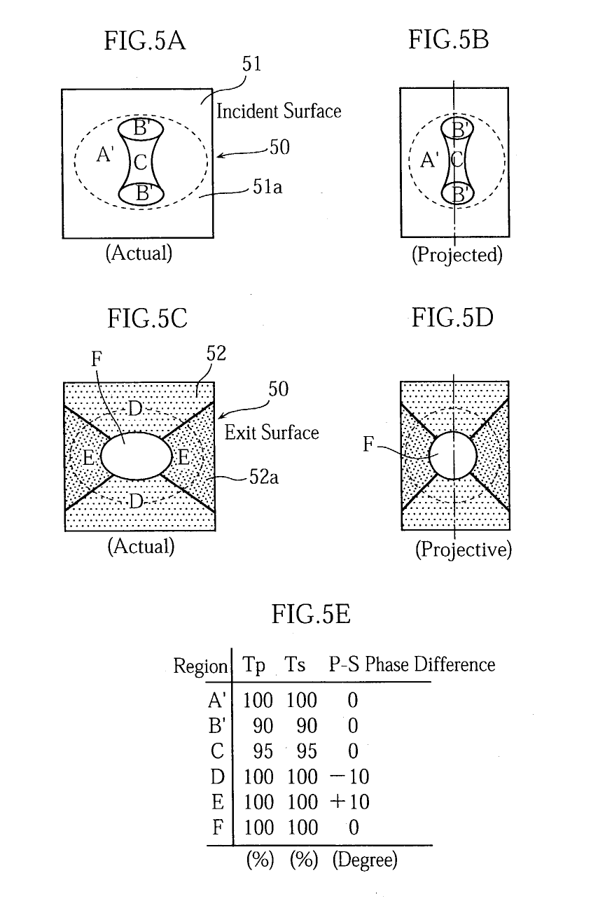

The dielectric layer 51a formed on the incident surface 51 may be divided into regions A′, B′ and C, as shown in FIG. 5A. FIG. 5B shows a projected image of the division shown in FIG. 5A. Likewise, the dielectric layer 52a formed on the exit surface 52 may be divided into regions D, E and F, as shown in FIG. 5C. FIG. 5D shows a projected image of the division shown in FIG. 5C. FIG. 5E shows a table of Tp, Ts and P-S phase difference for the respective regions A′, B′ and C-F.

In FIGS. 5A-5D, the closed broken line represents a region the return light Bm passes through. The division shown in FIG. 5A corresponds to the division of the lens pupil Ee shown in FIGS. 3 and 4. Specifically, the region A′ of FIG. 5A corresponds to the first paired regions A of FIG. 3 or 4, while the regions B′ of FIG. 5A correspond to the second paired regions B of FIG. 3 or 4. Thus, high-frequency reproduction signals are more likely to strike upon the region A′ of FIG. 5A, while stray signals from the adjacent tracks Tr are more likely to strike upon the regions B′. A mixture of these signals (and other signals) is present in the region C of FIG. 5A. As shown in the table of FIG. 5E, the values Tp and Ts of the region B′ are made lower than those of the other regions in order to reduce noise from the adjacent tracks. Further, the values Tp and Ts of the region C are slightly lower than those of the region A′ since the region C is abundant in low-frequency signals.

In the above-described embodiment, Tp and Ts do not need to be different from each other on the following grounds. As described with reference to FIG. 3, when the direction of polarization of the incident light is parallel to the recoding track Tr of the disk Dc, the high-frequency reproduction signals present in the region A′ are s-polarized, and the stray signals present in the regions B′ are p-polarized. In such an instance, the stray signals in the regions B′ can be reduced simply by making smaller Tp of the regions B′ than Tp of the region A′.

Similarly, in the case of FIG. 4, where the direction of polarization of the incident light is perpendicular to the recoding track Tr, the high-frequency reproduction signals present in the region A′ are p-polarized, and the stray signals present in the regions B′ are s-polarized. Thus, the noise prevention can be attained simply by making smaller Ts of the regions B′ than Ts of the region A′.

In a high-numerical-aperture region in the lens pupil Ee (the marginal region of the lens system 10), the phase of the p-polarized light can delay. For compensating this delay, the P-S phase difference is modulated by the dielectric layer 52a formed on the exit surface 52 of the second transparent member 50. Specifically, as shown in FIG. 5E, with respect to the region F that corresponds to the central portion of the return light Bm, no phase-difference compensation is performed so that the region F is optically transparent. With respect to the regions D (spaced from each other in a direction corresponding to the track-crossing direction), the phase difference is rendered negative (−10), while with respect to the regions E (spaced from each other in a direction corresponding to the track-extending direction), the phase difference is rendered positive (+10).

Referring back to FIG. 2, after passing through the second transparent member 50, the return light Bm enters the Wollaston prism 41. Since the p- and s-polarized components of the return light Bm are the same in phase, no elliptic polarization is introduced, and the polarized components resulting from the Kerr effect can be optimized for signal reproduction. Also, it is possible to reduce the stray signals.

The layout of the divided dielectric regions, the adjustment of the transmission factor and the compensation of the phase difference are not limited to those shown in FIGS. 5A-5E. For instance, when the P-S phase difference for the region F is +10, the P-S phase difference for the regions D may be 0 and the P-S phase difference for the regions E may be +20. The point here is that the P-S phase difference for the region F should be relatively great in comparison with that for the regions D, but relatively small in comparison with that for the regions E.

Regarding the region dividing, when the phase difference distribution of the return light Bm varies more sharply, the illustrated regions D and E may be subdivided radially, and for each subdivided region, an appropriate P-S phase difference may be determined.

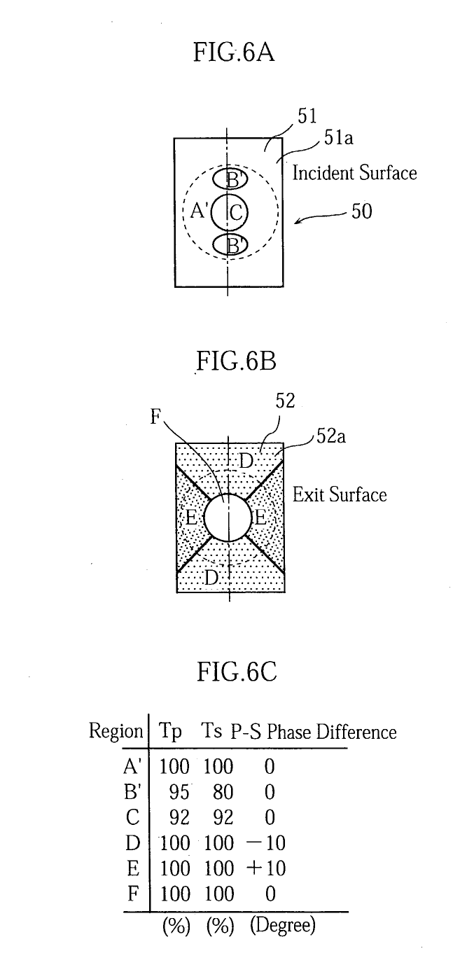

FIGS. 6A and 6B show another possible design for the dielectric layer division on the sides of the incident surface 51 and exit surface 52 of the second transparent member 50. FIG. 6C shows a table corresponding to that shown in FIG. 5E.

In the example of FIGS. 6A-6B, the region C, abundant in low-frequency reproduction signals, is made greater in size in the track-extending direction than the counterpart region shown in FIG. 5B. Accordingly, Tp and Ts for the region C are rendered smaller than those shown in FIG. 5E.

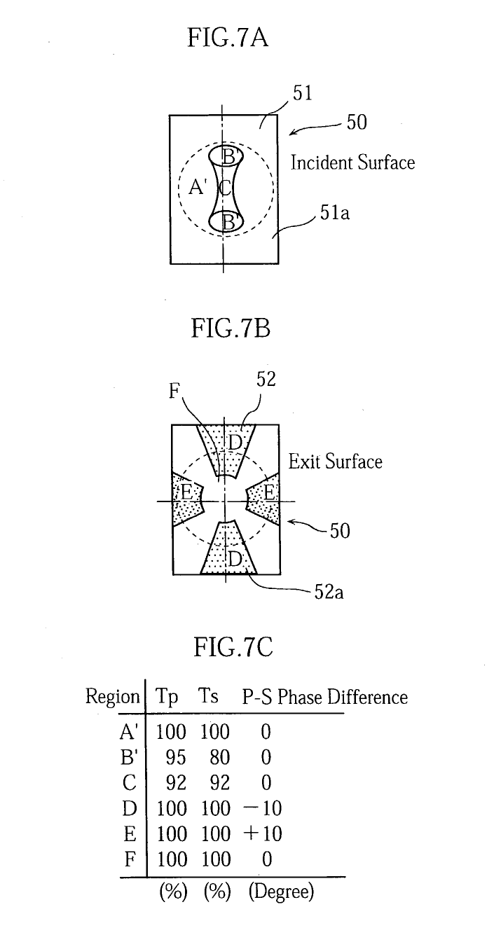

FIGS. 7A-7C show another example. In this case, the region F has four radially extending portions each of which is flanked by regions D and E.

According to the present invention, only one of the incident and exit surfaces 51, 52 of the second transparent member 50 may be inclined to the return light Bm, while the other may be perpendicular to it. In this case, the dielectric layer formed on the inclined surface is provided with the transmission adjusting function and the P-S phase difference compensating function.

As explained above, the present invention is advantageous to providing a high-quality optical disk reading/recoding apparatus with a high-NA lens system and a light source of a short wavelength.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. An optical disk apparatus comprising:
a light source for emitting light in a prescribed wavelength range;
an objective lens system for causing the light emitted from the light source to be focused onto a storage disk; and
a reproduction signal system for causing return light from the storage disk to be conduced to a detector;
wherein the light emitted from the light source has a direction of polarization parallel to a recoding track of the storage disk, the objective lens system having transmission factors for s-polarized light and p-polarized light that are defined relative to the objective lens system, the transmission factor for s-polarized light being greater than the transmission factor for p-polarized light.

2. The apparatus according to claim 1, wherein the objective lens system includes an objective lens and a transparent member located between the objective lens and the storage disk, at least one of the objective lens and the transparent member being formed with a transmission control film.

3. An optical disk apparatus comprising:
a light source for emitting light in a prescribed wavelength range;
an objective lens system for causing the light emitted from the light source to be focused onto a storage disk; and
a reproduction signal system for causing return light from the storage disk to be conducted to a detector;
wherein the light emitted from the light source has a direction of polarization perpendicular to a recoding track of the storage disk, the objective lens system having transmission factors for s-polarized light and p-polarized light that are defined relative to the objective lens system, the transmission factor for p-polarized light being greater than the transmission factor for s-polarized light.

4. An optical disk apparatus comprising:
a light source;
an objective lens system for causing light emitted from the light source to be focused onto a storage disk; and
a reproduction signal system for causing return light from the storage disk to be conducted to a detector, the reproduction signal system being provided with a transparent member having an incident surface and an exit surface;
wherein at least one of the incident surface and the exit surface is an inclined surface that is slant relative to the return light and covered by a dielectric layer.

5. The apparatus according to claim 4, wherein the return light includes a p-polarized component and an s-polarized component that are defined relative to the inclined surface, the transparent member being provided with a plurality of return light irradiating regions having different transmission factors resulting from the dielectric layer.

6. The apparatus according to claim 5, wherein the light emitted from the light source has a direction of polarization parallel to a recording track of the storage disk, and wherein the return light irradiating regions include first marginal regions spaced from each other in a direction corresponding to a track-crossing direction and a second marginal region different from the first marginal regions, the first marginal regions being smaller in transmission factor for polarized light than the second marginal region.

7. The apparatus according to claim 5, wherein the light emitted from the light source has a direction of polarization perpendicular to a recording track of the storage disk, and wherein the return light irradiating regions include first marginal regions spaced from each other in a direction corresponding to a track-crossing direction and a second marginal region different from the first marginal regions, the second marginal region being smaller in transmission factor for polarized light than the first marginal regions.

8. The apparatus according to claim 4, wherein the transparent member is provided with a plurality of regions having different P-S phase differences with respect to p-polarized and s-polarized components defined relative to the inclined surface.

9. The apparatus according to claim 8, wherein the plurality of regions include a first region corresponding to a center of the return light, second regions spaced in a direction corresponding to a track-crossing direction, and third regions spaced in a direction corresponding to a track-extending direction, and wherein a P-S phase difference given to the second regions is smaller than a P-S phase difference given to the first region, a P-S phase difference given to the third regions being greater than the P-S phase difference given to the first region.
